(19) United States
(12) Patent Application Publication
(10) Pub. No.: US 2003/0232631 A1
(43) Pub. Date: Dec. 18, 2003

(54) Portable telephone and communication method therefor

(75) Inventor: Yoshiaki Ohmori, Tokyo (JP)

Correspondence Address: YOUNG & THOMPSON, 745 SOUTH 23RD STREET 2ND FLOOR, ARLINGTON, VA, 22202

(73) Assignee: NEC CORPORATION, TOKYO (JP)

(21) Appl. No.: 10/455,414

(22) Filed: Jun. 6, 2003

(30) Foreign Application Priority Data
Jun. 14, 2002 (JP) 2002-174648

(51) Int. Cl. H04Q 7/20

(52) U.S. Cl. 455/552.1; 455/450

(57) ABSTRACT

A portable telephone includes a radio section, a main body storage section, an external storage section, and control sections. The radio section conforms to a plurality of communication systems. The main body storage section stores data representing a plurality of operators corresponding to mobile telephone systems and frequencies allocated to the plurality of operators. The external storage section stores a plurality of operators who provide communication services. The control sections control communication by different mobile telephone systems, acquire predetermined specification data associated with communication, perform communication at first on the basis of the specification data and at least one of the data stored in the main body storage section and the data stored in the external storage section, and then determine a cell search range for communication by another control section, thereby performing a cell search upon limiting the cell search range to a frequency band limited relative to a cell search range set without any specification data. A communication method for a portable telephone is also disclosed.

### BACKGROUND OF THE INVENTION

The present invention relates to a portable telephone which conforms to a plurality of mobile telephone systems (e.g., GSM scheme and third-generation (3G (generation 3)) portable telephone scheme) and, more particularly, to a portable telephone which achieves an increase in cell search speed and power saving, and a communication method for the portable telephone.

In a portable telephone system, in order to accommodate subscribers as many as possible within the limited frequency resource allocated to the system, transmission power is suppressed to a limited level so as to limit the range of radio waves. For this purpose, a technique called frequency reuse, in which the same frequency is redundantly used, is used between points relatively spaced apart from each other.

Although a portable telephone is a radio telephone, the distance actually connected by a radio channel is only several ten meters to several kilometers, and communication is mostly performed through a wire line over the remaining distance to the destination. In an area (service area) where communication can be performed using a portable telephone, radio base stations are arranged at intervals of several hundred meters to several kilometers.

The portable telephone of a user communicates with such a radio base station. In this case, the portable telephone selects a radio base station exhibiting the best communication quality. Since one radio base station allows communication within a very limited area, a plurality of radio base stations form areas called cells that can cover communication, which compensate for each other to allow mobile communication from any places.

A mobile terminal (portable telephone) performs communication using a radio base station in charge of communication within the cell to which the terminal belongs. When, however, the terminal has moved to another cell across the range of the cell to which the terminal belonged during communication, the terminal must perform communication by using a radio base station existing in the cell to which the terminal has moved. In this case, if the terminal can use only one radio base station, the communication is instantly interrupted at the moment of handoff to another radio base station to be used. In order to avoid such a problem, in a current mobile communication system, when a mobile terminal is located near the boundary of a plurality of cells, the terminal is allowed to simultaneously communicate with a plurality of radio base stations to prevent communication from being interrupted even when the mobile terminal moves between cells.

In order to realize such a technique, timing control must be done to allow a plurality of radio base stations located near a terminal to receive user data and cause data from the respective radio base stations to simultaneously arrive at the terminal. A base station controller is generally in charge of this task. Upon reception of user data to the terminal, the base station controller copies the data, and controls the transmission timing for each radio base station to cause the user data to arrive at a plurality of radio base stations at once.

In a conventional mobile communication system, when at least one of an originating terminal and a terminating terminal is located outside the area of a network to which the terminals are subscribed, even if they are present in one given area, the terminals cannot communicate with each other unless there is provided a service of connecting them.

For this reason, in order to receive an optimal service in consideration of various conditions, e.g., a communication area and communication cost, a user must subscribe to a plurality of services or own a plurality of portable telephones corresponding to the services, resulting in convenience.

To solve such a problem, a mobile terminal apparatus or mobile communication system portable telephone has been proposed, which allows a user to receive services from a plurality of communication common carriers with a single apparatus (Japanese Patent Laid-Open No. 10-262284):. In this system, for example, the first and second terminals are respectively subscribed to networks A and B. Assume that the first terminal is located within the areas of the networks A and B, and the second terminal is located within the area of the network B but located outside the area of the network A. In this case, when the first terminal sends out a connection request for the second terminal to the network A, a switching unit in the network A recognizes that the second terminal is not located in the area of the network A, and notifies a first terminal 11 of the corresponding information. Upon reception of the notification, the first terminal sends out a connection request for the second terminal to the network B. A switching unit in the network B connects the first terminal to the second terminal.

A new system of integrating a plurality of radio systems to allow one mobile radio unit to be used in the systems has also been proposed (Japanese Patent Laid-Open No. 8-228371). In this system, to allow a portable telephone to be used in the service area of another system, a portable telephone based on a system A is made to have the function of a portable telephone based on a system B, and an integrated radio control station is made to have the functions of both radio control stations in the systems A and B as a system integrating function.

A system which connects a portable telephone to an effective channel even in the service range of a communication common carrier other than the one in which the portable telephone is registered has already been practiced. Communication in the service area of another communication common carrier to which no contract of use has been made is called roaming. In Europe, international roaming based on the GSM (Global System for Mobile communication) scheme has been practiced. A technique of increasing the speed of connection to another effective channel has also been proposed (Japanese Patent Laid-Open No. 2001-103530).

A system according to this technique includes a communication means for transmitting/receiving radio signals, a storage means for storing a table associated with the pieces of identification information of a plurality of base stations and roaming information, and a control means. In this technique, the control means temporarily captures radio signals from a plurality of base stations in descending order of reception electric field strength. The control means acquires only base station identification information from each radio signal, compares/collates the base station identification information with the table, and selects a base station having the highest priority in accordance with the roaming information.

Various other problems are posed in constructing a system conforming to different international services like those described above. For example, different frequencies are allocated to different countries, areas, and communication common carriers. In addition, since different communication protocols and languages are used in different areas, it is difficult to manufacture a portable telephone apparatus that can be versatilely used in different countries. Furthermore, a portable telephone apparatus cannot be effectively used.

In consideration of such problems, in order to allow a telephone apparatus to be versatilely used in various areas, there has been proposed a technique of making the telephone apparatus have an oscillation means which oscillates/outputs various frequency signals used for transmission/reception processing and whose oscillation output frequency can be changed, a storage means for storing frequency information used for transmission/reception processing in correspondence with the identification information of areas or communication common carriers, and a control means which controls the oscillation means to output a necessary frequency signal on the basis of the frequency information in the storage means in accordance with the identification information of an area or communication common carrier to be used, and can change settings required for transmission/reception processing in accordance with the identification information of an area or communication common carrier to be used.

Even if, therefore, different frequency settings are made for the respective areas or communication common carriers to be used, the telephone apparatus can be used in each area by switching the settings, and a communication protocol or the like can be selectively used as needed (Japanese Patent Laid-Open No. 11-32111).

A mobile radio terminal apparatus has also been proposed, which improves convenience by making various settings in accordance with countries or areas without making the user become conscious of the countries or areas (Japanese Patent Laid-Open No. 2001-57688).

A portable telephone sequentially receives frequency bands used in a plurality of radio communication systems and detects a radio communication system that can be used. The portable telephone then performs communication by using identification data corresponding to the detected radio communication system. With this operation, since identification data that can be used in a communication system in a country or area where the portable telephone is to be used is automatically set, the user can perform communication without setting any identification data in consideration of a country or area where the portable telephone is to be used.

The functions of a portable telephone include a function called “cell search” that searches for a base station to register a position. In general, a cell search is effected when the portable telephone is powered on at first or located outside the service area. In an FDM (Frequency Division Multiplexing) scheme, this cell search is performed as follows: sequentially receiving radio waves in frequency steps within the frequency band allocated to a mobile telephone system, and detecting whether or not the radio waves transmitted from each base station for each frequency can be received, thereby searching for a base station.

To a mobile telephone system designed in consideration of use in a plurality of countries, like a third-generation (3G) portable telephone scheme, a frequency band common to the respective countries is basically allocated. However, different frequency bands are allocated to communication common carriers (operators) who provide communication services depending on the countries. In this case as well, if a country where the portable telephone is to be used is known in making a cell search, an operator who is providing a service to the portable telephone in the country is specified. In addition, if the frequency band allocated to the corresponding operator in the country is known, a cell search may be made within the known frequency band.

A general portable telephone, however, has not received the notification information transmitted from a base station before a cell search, and hence cannot specify its own position (MCC). In the prior art, in cell search operation, the portable telephone has no choice but to search for all the frequencies allocated to a mobile telephone system to which the telephone corresponds. For this reason, it takes much time to make a cell search, resulting in an increase in power consumption and making the user wait during the search.

The existing methods of shortening the time required for a cell search include methods closed within a single system. For example, such methods include a method of storing, in the storage means of a portable telephone, a list of frequencies which exhibit previous successes in position registration in a given portable telephone system, and setting only frequencies in the list as cell search targets in the system.

In, for example, a place where a user visits for the first time, a necessary amount of data is not accumulated in the above frequency list, and hence no cell search target range can be specified. This method cannot therefore solve the problem of the necessity to search for all frequencies.

As a method of grasping the position of a portable telephone, a method of using GPS (Global Positioning Systems) or the like is conceivable. However, this method requires mounting of special equipment such as a GPS receiver. In addition, even the proposals in the above references have no recognition of technical problems in terms of preventing a user from waiting during a search by realizing such high-speed cell search operation and suppressing power consumption. Consequently, there are no technical proposals that focus on the problems from such viewpoints.

### SUMMARY OF THE INVENTION

It is an object of the present invention to provide a portable telephone which can realize high-speed cell search operation and power saving, and a communication method for the portable telephone.

In order to achieve the above object, according to the present invention, there is provided a portable telephone comprising radio means which conforms to a plurality of communication systems, first storage means which stores data representing a plurality of operators corresponding to mobile telephone systems and frequencies allocated to the plurality of operators, second storage means which stores a plurality of operators who provide communication services, and a plurality of communication control means for controlling communication by different mobile telephone systems, acquiring predetermined specification data associated with communication, performing communication at first on the basis of the specification data and at least one of the data stored in the first storage means and the data stored in the second storage means, and then determining a cell search range for communication by another communication control means, thereby performing a cell search upon limiting the cell search range to a frequency band limited relative to a cell search range set without any specification data.

### BRIEF DESCRIPTION OF THE DRAWINGS

FIG. 1 is a view for explaining the flow of communication control operation of a portable telephone according to the present invention;

FIG. 2 is a block diagram showing an overall conceptual arrangement of a portable telephone according to the first embodiment of the present invention;

FIG. 3 is a conceptual view showing the contents of a table which is stored in a storage section of the portable telephone and represents the relationship between MCCs, the names (IDs) of operators who are providing communication services in the corresponding countries, and the frequency bands allocated to the respective operators;

FIG. 4 is a conceptual view showing the contents of a table which is stored in an external storage section of the portable telephone and indicates operators who are allowed to provide communication services to the portable telephone;

FIG. 5 is a view showing the condition of all frequencies allocated to a communication system; and

FIG. 6 is a block diagram showing an overall conceptual arrangement of a portable telephone according to the second embodiment of the present invention.

### DESCRIPTION OF THE PREFERRED EMBODIMENTS

The first embodiment of the present invention will be described in detail below.

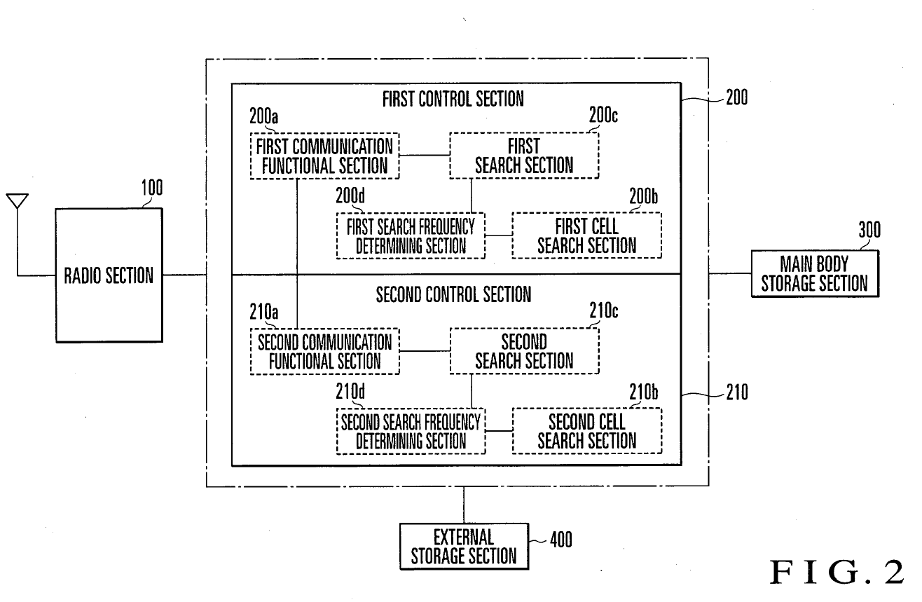

FIG. 2 shows an overall conceptual arrangement of a portable telephone according to the present invention. Referring to FIG. 2, reference numeral 100 denotes a radio section including an antenna. This radio section conforms to both a system A (e.g., a mobile telephone system based on a GSM scheme) and a system B (e.g., a mobile telephone system based on a third-generation portable telephone scheme).

Reference numeral 200 denotes a first control section which is associated with the system A and connected to the radio section 100. The first control section 200 controls communication in a form conforming to communication by a mobile telephone system based on, for example, a GSM scheme.

Reference numeral 210 denotes a second control section which is used for the system B and connected to the radio section 100. The second control section 210 controls communication in a form conforming to communication by a mobile telephone system based on, for example, a third-generation portable telephone scheme.

Reference numeral 300 denotes a storage section which is incorporated in the body of the self-apparatus and connected to the first control section 200 and second control section 210.

Reference numeral 400 denotes an external storage section which is typified by a SIM (Subscriber Identity Module) and connected to the first control section 200 and second control section 210. The external storage section 400 is formed from a memory unit detachably mounted in the portable telephone body.

The first control section 200 includes a first communication functional section 200a, a first cell search section 200b, a first search section 200c connected to the first communication functional section 200a, and a search frequency determining section 200d connected to the first search section 200c and first cell search section 200b.

The second control section 210 includes a second communication functional section 210a connected to the first communication functional section 200a, a second cell search section 210b, a second search section 210c connected to the second communication functional section 210a, and a second search frequency determining section 210d connected to the second cell search section 210b.

The first communication functional section 200a acquires a country code (MCC) from a reception signal from the radio section 100. The first cell search section 200b makes a cell search. The first search section 200c searches a frequency allocation list stored in the storage section 300 and a service operator list stored in the external storage section 400. The search frequency determining section 200d determines a frequency range in which a cell search for a cell search on the basis of the search result from the first search section 200c.

The second communication functional section 210a acquires a country code (MCC) from a reception signal from the radio section 100. The second cell search section 210b makes a cell search. The second search section 210c searches a frequency allocation list stored in the storage section 300 and a service operator list stored in the external storage section 400. The second search frequency determining section 210d determines a frequency range for a cell search on the basis of the search result from the second search section 210c.

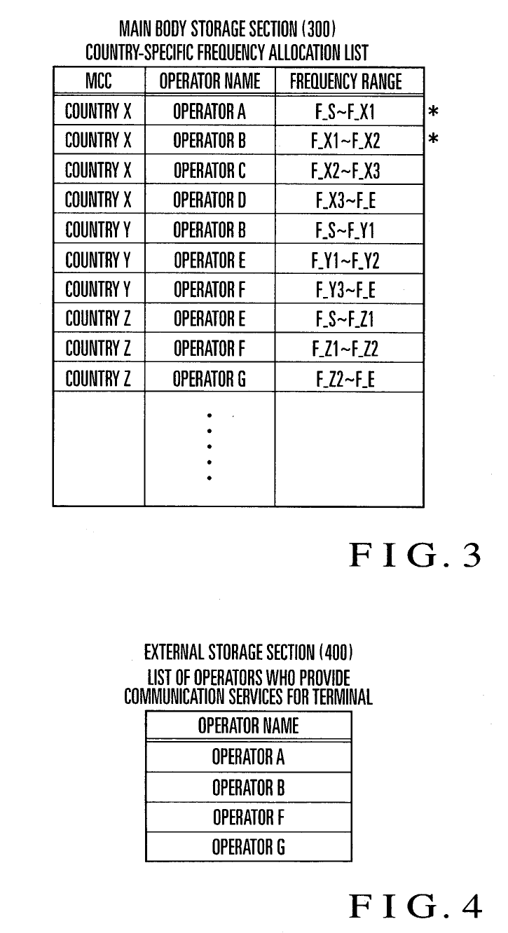

FIG. 3 shows the contents of a table (to be referred to as a “frequency allocation list” hereinafter) which is stored in the storage section 300 and represents the relationship between MCCs, the names (IDs (Identifications)) of operators who provide communication services in the corresponding countries, and frequency bands allocated to the operators.

Note that an MCC (Mobile Country Code) is a code that represents a country to which a base station that provides a communication service for a mobile communication terminal such as a portable telephone at its current position belongs. Such MCCs are known (e.g., U.S. patent application Ser. No. 2002/0025824).

FIG. 4 shows the contents of a table (to be referred to as a “service operator list” hereinafter) which is stored in the external storage section 400 and represents operators who are allowed to provide communication services to the portable telephone.

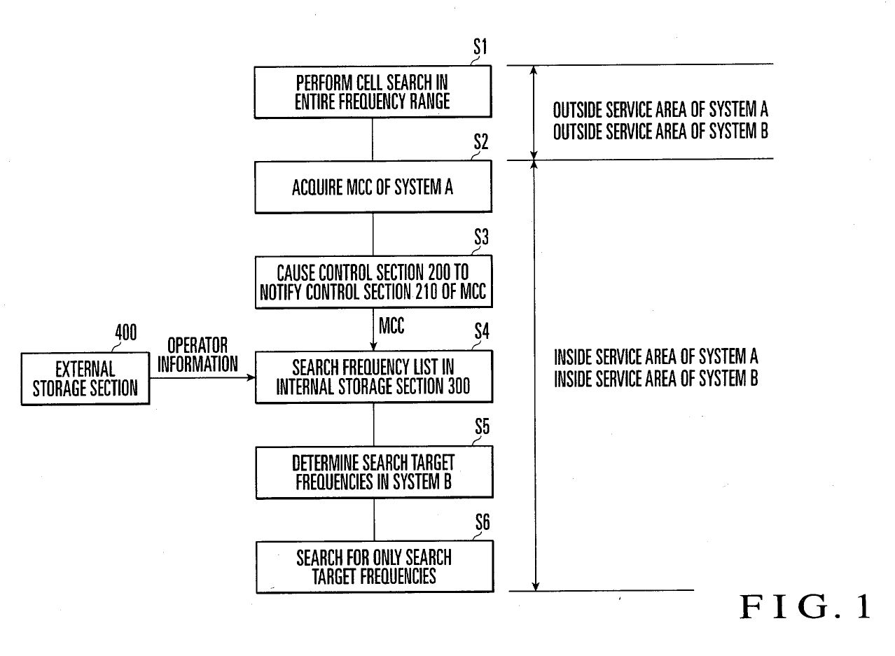

The flow of the communication control operation of the portable telephone according to the present invention will be described below with reference to FIG. 1. For the sake of descriptive convenience, a portable telephone is assumed, which conforms to two types of mobile telephone systems, namely the system A and system B. However, the present invention is not limited to an apparatus conforming to two types of systems as described above, and can be applied to an arrangement suitable for communication by a larger number of mobile communication systems.

The following is a case wherein the effect external storage section 400 is inserted in the main body. If, however, the external storage section 400 is not inserted in the main body, the apparatus of this embodiment is designed so as not to perform cell search operation of the present invention (but is designed to perform normal cell search operation).

When the apparatus of this embodiment is powered on at first or located outside both the service areas of the mobile telephone systems A and B, the first cell search section 200b of the first control section 200 and the second cell search section 210b of the second control section 210 perform conventional cell search operation (S1).

The first communication functional section 200a of the first control section 200 (one communication functional section) finds a base station belonging to the system A, and acquires a country code (MCC) from the notification information transmitted from the base station belonging to the system A (the mobile telephone system based on the GSM scheme) (S2).

The first communication functional section 200a of the first control section 200 notifies the second communication functional section 210a of the second control section 210 (another communication functional section) of the acquired country code (MCC) (S3). Upon reception of the country code (MCC), the second communication functional section 210a inputs the country code (MCC) to the second search section 210c.

On the basis of the country code obtained from the first control section 200 (another communication functional section) and the data of the service operator list (FIG. 4) stored in the external storage section 400 (second storage section), the second search section 210c of the second control section 210 (one communication functional section) searches the frequency allocation list (FIG. 3) stored in the storage section 300 (first storage section) in the main body for an item with which the combination of the country information and the operator coincides (S4).

If the search result indicates that a frequency with which the combination of the country information and the operator coincides is stored in the frequency allocation list (FIG. 3), the second search frequency determining section 210d determines the frequency as a cell search target associated with the system B (S5). In this case, if there are a plurality of corresponding frequencies, all the frequencies are set as cell search targets.

If no item with which the combination of the MCC and the operator coincides is found as the result of searching the frequency allocation list (FIG. 3), the second search frequency determining section 210d cannot specify any frequency as a search target. Therefore, all the frequencies allocated to the communication system are set as search targets as in the prior art.

The second cell search section 210b of the second control section 210 executes a cell search with respect to a search target frequency in the system B which is obtained in step S5 (S6).

This cell search range is limited relative to the range of the initial cell search (S1). Subsequently, the cell search in step S6 is repeated.

The processing in steps S4 and S5 will be described further in detail. Assume that the contents of a frequency allocation list are the same as those shown in FIG. 3, the contents of a service operator system are the same as those shown in FIG. 4, and the MCC acquired by the system A is “country X”.

[I] It is obvious from the data of the service operator list (FIG. 4) that the operators who provide services for the portable telephone are “operator A”, “operator B”, “operator F”, and “operator G”.

[II] It is obvious that the MCC of the system A is “country X”.

[III] When the frequency allocation list (FIG. 3) is searched for items which coincide with the information in [I] and the information [II], it is found that the items “country X, operator A” and “country X, operator B” (indicated by [symbol] in FIG. 3) coincide with these pieces of information.

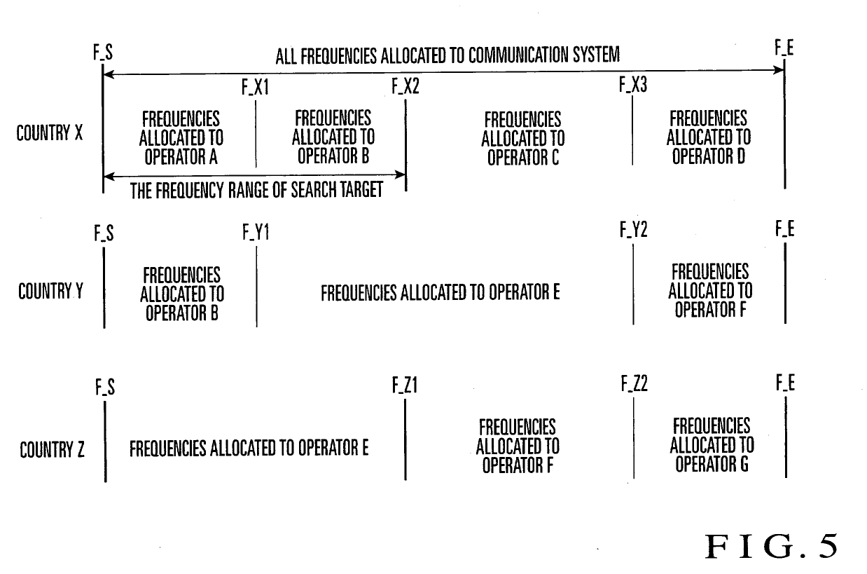

It can therefore be determined that “F_S to F_X1” and “F_X1 to F_X2” (indicated by [symbol] in FIG. 3) are the frequencies to be searched out in the system B (see FIG. 5 showing the condition of all frequencies allocated to the communication system).

If this terminal has moved out of the service area of the system A in the state in step S6, the first communication functional section 200a of the first control section 200 notifies the second communication functional section 210a of the second control section 210 that the terminal has moved out of the service area.

The second communication functional section 210a of the second control section 210 then starts the timer. This operation is done to prevent the flow of processing from returning step Si immediately after the terminal has moved out of the service area.

If the system A acquires an MCC again before the timer expires, it is checked whether the MCC coincides with the value used until just before.

If the MCC coincides with the value used until just before, the flow returns to step S6. If the MCC differs from the value used until just before, the processing is resumed from step S3.

When the timer expires, the second cell search section 210b of the second control section 210 switches the frequencies as search targets to all the frequencies allocated to the system B, and the flow returns to operation (step S1) to be done when the terminal is located outside the services areas of the systems A and B.

If the MCC of the system A changes to another country (country Y) in the state in step S6 described above, e.g., the terminal has crossed the border, the first communication functional section 200a of the first control section 200 notifies the second communication functional section 210a of the second control section 210 of the MCC of the country Y.

The processing is then resumed from step S4.

With the above processing, since frequencies as search targets can be limited in number, an increase in the speed of search processing and power saving can be achieved as compared with the conventional method of setting all frequencies as search targets.

According to the above embodiment, as compared with the conventional method of always setting all the frequencies allocated to the communication system as cell search targets, the time required to perform a cell search in the system B can be shortened, and the time for which the user needs to wait during power saving operation or a search can be shortened because when the system A acquires an MCC from notification information transmitted from a base station, the number (range) of search target frequencies can be decreased by using the information.

For example, in the third-generation (3G) portable telephone scheme, all the frequencies allocated to the system correspond to as many as about 300 channels. If, the time required for one channel search is 100 ms, it takes about 30 sec to perform search operation as a whole. If, for example, the number of frequencies as search targets is reduced to 70 channels, the time required for search operation is 7 sec, which is about ¼ the time required before.

In general, when a base station is detected by a cell search, notification information transmitted from the base station must be acquired. In this case, however, whether the acquired notification information has been transmitted from an operator who is providing a communication service for the portable telephone cannot be determined until the contents of the information are analyzed, wasteful processing of acquiring notification information from operators who are providing no services to the terminal must be done.

According to the present invention, the frequency range of search targets is limited to the frequencies of operators who are providing communication services to the portable telephone in a given country, there is no need to perform the above wasteful processing of acquiring notification information from operators who are providing no communication services to the terminal, leading to a more noticeable reduction in power consumption. That is, in this embodiment, the frequencies of operators who are providing no services are excepted from cell search targets. This saves wasteful operation of searching and detecting base stations of operators who make no contribution to communication using the self-terminal. Note that the above communication control can be realized without using any special apparatus such as a GPS.

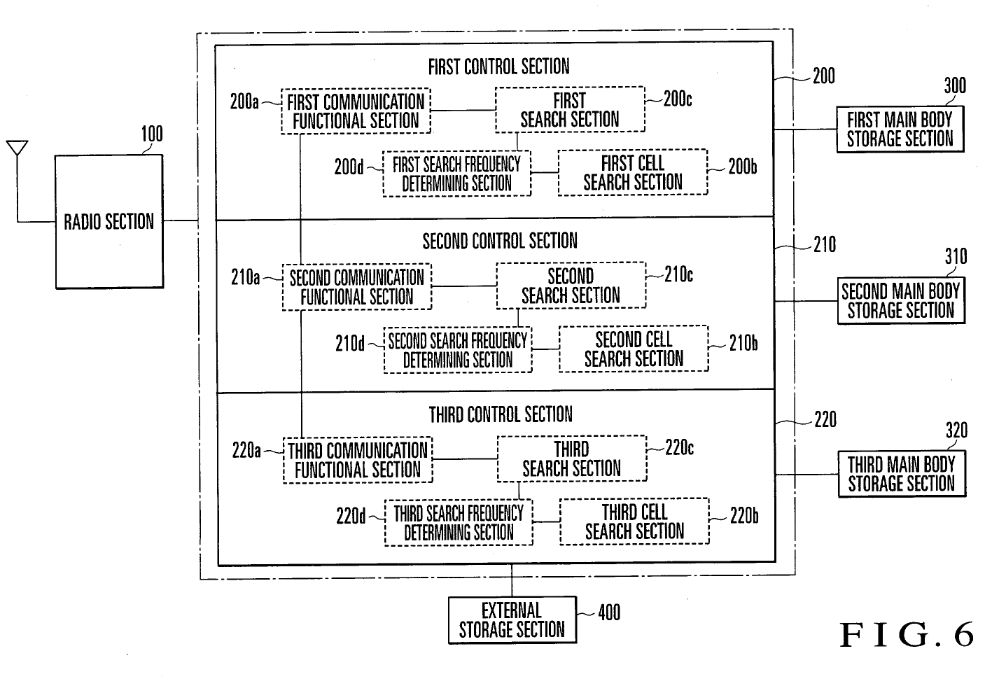

The second embodiment of the present invention will be described next with reference to FIG. 6.

The first embodiment has exemplified the portable telephone which supports the two types of systems, i.e., the systems A and B. As described above, however, a portable telephone may support more than two systems (n types). For example, for a portable telephone which supports three types of systems, i.e., systems A, B, and C, a frequency allocation list (FIG. 3) for each system is prepared in the main body storage section. When an MCC is obtained from the system A, the terminal searches the above list in the main body storage section to reduce the numbers of cell search target frequencies in the systems B and C.

More specifically, this portable telephone is equivalent to the portable telephone of the first embodiment which includes a third control section 220. Like a first control section 200 and second control section 210, the third control section 220 includes a third communication functional section 220a, third cell search section 220b, third search section 220c, and third search frequency determining section 220d. Each function is the same as that described in the first embodiment. In addition, a first main body storage section 300, second main body storage section 310, and third main body storage section 320 are respectively provided for the first control section 200, second control section 210, and third control section 220.

In the apparatus shown in FIG. 2, a frequency allocation list (FIG. 3) is prepared in the main body storage section (300). However, this list may be stored in a section other than the main body storage section.

For example, the same contents as those of the above list may be stored in a SIM card serving as an external storage section 400, and information may be retrieved from the card in the operation step (S4) described above.

The above list may be stored in a server on a network, and the frequency allocation list (FIG. 3) may be updated periodically or in accordance with arbitrary operation by the user while the terminal is located in the service area. This makes it possible to update the frequency allocation list (FIG. 3) on the basis of data acquired from the server even if the frequency allocation for each country is changed, thereby coping with the frequency allocation for each counter after the change.

The above apparatus uses only country codes (MCCs). If, however, for example, a more accurate position (area) can be known from another information from the system A, the number of frequencies as search targets may be further decreased by using the information. Assume that it is known from information from the system A that the terminal is located in an area Z in a country X. In this case, any frequency that is not used in the area Z can be excepted from search targets.

A cell search in the system B may be stopped depending on information from the system A. Assume that the MCC of a country in which no service from the system B is provided is recorded in advance in the frequency allocation list (FIG. 3). In this case, if it is known from the MCCs obtained from the system A that the portable telephone is located in this country, a cell search in the system B is stopped.

The arrangement of the portable telephone is not limited to those shown in FIGS. 2 and 6. For example, the control sections need not be separately provided for the respective systems, and radio sections 100 may be separately provided for the respective systems.

The arrangements and operations of the preferred embodiments of the portable telephone and the communication method therefor according to the present invention have been described in detail above. However, these embodiments are merely examples and are not intended to limit the present invention. It will be obvious to those skilled in the art that various changes and modifications may be made within the spirit and scope of the present invention in accordance with specific application purposes.

There are provided a portable telephone which can realize high-speed cell search operation and power saving, and a communication method for the portable telephone.

What is claimed is:

1. A portable telephone comprising:
radio means which conforms to a plurality of communication systems;
first storage means which stores data representing a plurality of operators corresponding to mobile telephone systems and frequencies allocated to the plurality of operators;
second storage means which stores a plurality of operators who provide communication services; and
a plurality of communication control means for controlling communication by different mobile telephone systems, acquiring predetermined specification data associated with communication, performing communication at first on the basis of the specification data and at least one of the data stored in said first storage means and the data stored in said second storage means, and then determining a cell search range for communication by another communication control means, thereby performing a cell search upon limiting the cell search range to a frequency band limited relative to a cell search range set without any specification data.

2. A telephone according to claim 1, wherein each of said plurality of communication control means comprises communication functional means for acquiring predetermined specification data associated with communication,
search means for searching for a cell search range for communication by another communication control means after communication is performed at first on the basis of the specification data and at least one of the data stored in said first storage means and the data stored in said second storage means,
search frequency determining means for determining a frequency for a cell search on the basis of an output from said search means, and
cell search means for performing a cell search in accordance with an output from said search frequency determining means.

3. A telephone according to claim 1, wherein said plurality of communication control means comprise
communication control means which conforms to communication by a mobile telephone system based on a GSM scheme, and
communication control means which conforms to communication by a mobile telephone system based on third-generation portable telephone scheme.

4. A telephone according to claim 1, wherein said first storage means comprises a memory unit incorporated in a portable telephone body.

5. A telephone according to claim 1, wherein said second storage means comprises a memory unit detachably mounted in a portable telephone body.

6. A telephone according to claim 1, wherein said second storage means comprises a memory unit incorporated in a portable telephone body.

7. A telephone according to claim 1, wherein said first storage means comprises a memory unit detachably mounted in a portable telephone body.

8. A telephone according to claim 5, wherein said plurality of communication control means relatively limits a cell search range when said second storage means is mounted in the portable telephone body.

9. A telephone according to claim 2, wherein said communication functional means acquires an MCC (Mobile Country Code) as specification data.

10. A telephone according to claim 1, further comprising:
a server which is provided for a mobile telephone system and stores at least one of the data stored in said first storage means and the data stored in said second storage means; and
means for updating the data stored in said server.

11. A telephone according to claim 2, wherein each of said plurality of communication control means is configured so as not to execute a cell search for communication by another communication functional means when recognizing, on the basis of predetermined specification data acquired by performing communication at first by one of the plurality of mobile telephone systems to which one of said communication functional means conforms and at least one of the data stored in said first storage means and the data stored in said second storage means, that said portable telephone is currently located in an area where no operator provides any service for communication by another communication functional means.

12. A communication method for a portable telephone, comprising the steps of:
causing communication control means for controlling communication conforming to communication by a plurality of mobile telephone systems to perform communication by one of the mobile telephone systems and acquiring predetermined specification data associated with the communication; and
executing, after the communication in the acquiring step, a cell search for communication by another mobile telephone system upon limiting a cell search range relative to a cell search range associated with the communication in the acquiring step.

13. A method according to claim 12, wherein the acquiring step comprises the step of performing communication by a mobile telephone system based on a GSM scheme, and
the executing step comprises the step of performing communication by a mobile telephone system based on a third-generation portable telephone scheme.

14. A method according to claim 12, wherein
the acquiring step comprises the step of performing communication by a mobile telephone system based on a third-generation portable telephone scheme, and
the executing step comprises the step of performing communication by a mobile telephone system based on a GSM scheme.

15. A method according to claim 12, wherein the executing step comprises the step of performing a relatively limited cell search on the basis of predetermined specification data which is acquired by performing communication by one mobile telephone system in the acquiring step and associated with the communication and at least one of data representing frequencies respectively allocated to operators corresponding to a plurality of mobile telephone systems and data representing the respective operators.

16. A method according to claim 15, wherein the data representing the frequencies respectively allocated to the operators corresponding to the plurality of mobile telephone systems is stored in advance in a memory unit incorporated in a portable telephone body.

17. A method according to claim 15, wherein the data representing the respective operators is stored in advance in a memory unit detachably mounted in a portable telephone body.

18. A method according to claim 17, wherein the executing step further comprises the step of relatively limiting a cell search range when the memory unit is mounted in the portable telephone body.

19. A method according to claim 12, wherein the acquiring step comprises the step of acquiring an MCC (Mobile Country Code) as the predetermined specification data associated with the communication.

20. A method according to claim 15, further comprising the step of updating, in accordance with data held in a server provided for a mobile telephone system, at least one of the data representing the frequencies respectively allocated to the operators corresponding to the plurality of mobile telephone systems and data representing the respective operators.

21. A method according to claim 15, wherein the acquiring step further comprises the step of inhibiting a cell search when it is recognized, on the basis of the predetermined specification data which is obtained by performing communication by one mobile telephone system and associated with the communication and at least one of the data representing the frequencies respectively allocated to the operators corresponding to the plurality of mobile telephone systems and the data representing the respective operators, that the portable telephone is currently located in an area where no operator provides any service for communication by another communication functional means.
